(19) United States
(12) Patent Application Publication
(10) Pub. No.: US 2026/0213457 A1
(43) Pub. Date: Jul. 23, 2026

(54) MOUNTING STRUCTURE, MOUNTING MEMBER AND CONNECTION STRUCTURE

(71) Applicant: IRISO ELECTRONICS CO., LTD., Yokohama-shi (JP)

(72) Inventors: Hitoshi TANAKA, Yokohama-shi (JP); Katsumasa SATO, Yokohama-shi (JP)

(21) Appl. No.: 19/142,661

(22) PCT Filed: Nov. 21, 2023
(86) PCT No.: PCT/JP2023/041880

§ 371 Date: Jun. 24, 2025

(30) Foreign Application Priority Data
Dec. 28, 2022 (JP) 2022-211742

(51) Int. Cl. H01R 13/533; H01R 12/70; H01R 12/71; H01R 12/91; H01R 13/187

(52) U.S. Cl. CPC H01R 13/533; H01R 12/7011; H01R 12/716; H01R 12/91; H01R 13/187

(57) ABSTRACT

There is provided a mounted member that, in a structure having a supporting portion and an extending portion having a shape of extending from the supporting portion, can suppress vibration of the extending portion.

A mounting target object 18 has a supporting portion 20, and plural extending portions 30 having shapes of extending from the supporting portion 20. A mounted member 19 has base portion side contacting portions 51, 52a, 61, 62 and non-base portion side contacting portions 52b, 63. The base portion side contacting portions 51, 52a, 61, 62 contact at least one of the supporting portion 20 and base portions 31. The non-base portion side contacting portions 52b, 63 contact non-base portions 32.

### TECHNICAL FIELD

The present disclosure relates to a mounting structure, a mounted member, and a connecting structure.

### BACKGROUND ART

Structures such as that disclosed in Patent Document 1 are conventionally known. In this structure, a male member electrically connects two substrates via two female terminals.

### PRIOR ART DOCUMENTS

### Patent Documents

Patent Document 1: Japanese Patent Application Laid-Open (JP-A) No. 2009-129858

### SUMMARY OF INVENTION

### Technical Problem

In the above-described structure, if the distance between the substrates is large, the length of the male member also is large. The longer the male member, the more the natural frequency decreases, and the greater the possibility that resonance will arise when the structure is placed in a vibration environment. As a result, it is easy for problems, such as the male member breaking, or slight sliding wear arising at the portions of contact between the male member and the female terminals, to occur.

As a method of suppressing resonance without changing the distance between the substrates, methods have been contemplated of raising the natural frequency by making the plate thickness or the width of the male member larger, or by changing the material of the male member to a material of high rigidity. However, the aforementioned methods cannot be employed in cases in which changes to the male member are not possible. Further, even if changes to the male member are possible, processes of selecting the materials, changing the design, or forming the molds are necessary, and much time and cost are required.

One object of the present disclosure is to provide a mounted member that, in a structure having a supporting portion and an extending portion having a shape of extending from the supporting portion, can suppress vibration of the extending portion, and to provide a mounting structure using the mounted member.

### Solution to Problem

A mounting structure relating to a first aspect is a mounting structure that includes a mounting target object and a mounted member mounted to the mounting target object, wherein the mounting target object has a supporting portion, and an extending portion supported at the supporting portion and having a shape of extending from the supporting portion, and the extending portion has a base portion that is a portion near the supporting portion, and a non-base portion that is a portion far from the supporting portion, and the mounted member has a base portion side contacting portion that contacts at least one of the supporting portion and the base portion, and a non-base portion side contacting portion that contacts the non-base portion.

In the present aspect, the mounting structure has the mounting target object. The mounting target object has the supporting portion, and the extending portion that has a shape of extending from the supporting portion.

Although the extending portion is supported by the supporting portion, the extending portion has a shape of extending from the supporting portion, and therefore, it is easy for the natural frequency of the extending portion to be low. In a case in which the mounting structure is placed in a vibration environment, if the frequency of the vibration environment is near the natural frequency of the extending portion, there is the concern that resonance will occur and that the extending portion will vibrate greatly.

Further, in the present aspect, the mounting structure has the mounted member that is mounted to the mounting target object. The mounted member has a base portion side contacting portion and a non-base portion side contacting portion. The base portion side contacting portion contacts at least one of the supporting portion and the base portion, and the non-base portion side contacting portion contacts the non-base portion. Note that base portion means the portion of the extending portion that is near to the supporting portion, and non-base portion means the portion of the extending portion that is far from the supporting portion.

Therefore, the natural frequency of the extending portion to which the mounted member is mounted is higher than the natural frequency of the extending portion to which the mounted member is not mounted.

Accordingly, in accordance with the present aspect, the natural frequency can be adjusted by the mounted member, and as a result, vibration of the extending portion can be suppressed.

Note that, in an embodiment that is described hereinafter, an example is described in which the extending portion is a rod-shaped portion that extends rectilinearly. However, the extending portion of the present aspect is not limited to this. For example, the extending portion of the present aspect may be a rod-shaped portion that includes a curved portion, or may be a plate-shaped portion (a portion or member formed in the shape of a plate).

Further, in the embodiment that is described hereinafter, an example is described in which the base portion side contacting portion contacts both the supporting portion and the base portion.
However, the base portion side contacting portion of the present aspect is not limited to this. The base portion side contacting portion of the present aspect may be a portion that contacts the base portion and does not contact the supporting portion, or may be a portion that contacts the supporting portion and does not contact the base portion.
Further, in the embodiment that is described hereinafter, an example is described in which the supporting portion and the extending portion are formed of different materials, but the present aspect is not limited to this. The supporting portion and the base portion may be formed integrally of the same material.
Further, in the embodiment that is described hereinafter, an example is described in which the supporting portion supports the base portion side of the extending portion so as to not move.

However, the present aspect is not limited to this. For example, the supporting portion of the present aspect may be a female terminal (refer to Patent Document 1) to which a male member serving as an extending portion is connected. In this case, the portion that the base portion side contacting portion contacts may be the leg portions of the female terminal, or may be a circuit board or another member (a housing or the like).

Further, although the embodiment that is described hereinafter describes an example in which the extending portion is a conductive member, the extending portion of the present disclosure is not limited to this.
Further, in the embodiment that is described hereinafter, an example is described in which the object that has the mounting structure is the connection target object of a connector. However, the present aspect is not limited to this. The object that has the mounting structure of the present aspect does not have to be a connection target object. For example, the portion of the extending portion, which portion is at the side opposite the side supported by the supporting portion, may be directly joined to a substrate and not a connector. Further, the portion of the extending portion, which portion is at the side opposite the side supported by the supporting portion, does not have to be connected or joined to another member or part.
Further, although the embodiment that is described hereafter describes an example in which the mounting target object has plural extending portions, and the plural extending portions are supported by the supporting portion, the present aspect is not limited to this. The number of extending portions that the mounting target object of the present aspect has may be one.
Further, in the embodiment that is described hereinafter, an example is described in which the border between the base portion and the non-base portion at the extending portion is a portion whose cross-sectional shape varies, but the present aspect is not limited to this. In the present aspect, the border between the base portion and the non-base portion at the extending portion is not clearly prescribed, and does not have to be prescribed.

In a mounting structure relating to a second aspect, in the first aspect, at least one of the base portion side contacting portion and the non-base portion side contacting portion contacts the mounting target object from two directions that face one another.

In the present aspect, at least one of the base portion side contacting portion and the non-base portion side contacting portion contacts the mounting target object from two directions that face one another.

Therefore, the natural frequency relating to vibrations in the two directions that face one another can be raised effectively.

Note that the present aspect includes a case in which the mounted member is mounted to the mounting target object by press-fitting. In this case, if at least one of the base portion side contacting portion and the non-base portion side contacting portion does not contact the mounting target object from other than the two directions that face one another, surfaces other than surfaces in these two directions are not rubbed at the time of press-fitting. The surfaces not being rubbed at the time of press-fitting can suppress scraping of the surfaces of the mounting target object and the mounted member. In a case in which the extending portion is a terminal, it is preferable that the surface, which is not scraped at the time of press-fitting, be the surface that contacts the partner terminal.

In a mounting structure relating to a third aspect, in the first or second aspect, the mounted member has a contacting member that contacts the mounting target object, and the contacting member has a pair of nipping members that are a pair of nipping members formed as bodies separate from one another and that are disposed so as to nip the mounting target object.

In the present aspect, the mounted member has the contacting member that contacts the mounting target object. The contacting member has a pair of nipping members that are formed as bodies separate from one another. The pair of nipping members are disposed so as to nip the mounting target object.

Therefore, the work of mounting the mounted member to the mounting target object is not press-fitting. As a result, scraping of the surfaces of the mounting target object and the mounted member at a time of press-fitting can be avoided.
Note that, although the embodiment that is described hereinafter describes an example in which the mounted member further has a maintaining member, the present aspect is not limited to this.
In a case in which the mounted member does not have a maintaining member, the pair of nipping members themselves may have a structure for maintaining the state in which the pair of nipping members are disposed so as to nip the mounting target object. Examples of such a structure are a structure in which claw portions and hole portions engage, or an adhesive.

In a mounting structure relating to a fourth aspect, in the third aspect, the mounted member has a maintaining member formed as a body separate from the pair of nipping members, and the maintaining member maintains a state in which the pair of nipping members are disposed so as to nip the mounting target object.

In the present aspect, the mounted member has a maintaining member formed as a body separate from the pair of nipping members. The maintaining member maintains the state in which the pair of nipping members are disposed so as to nip the mounting target object.

Therefore, there is no need for the pair of nipping members themselves to have a structure for maintaining the above-described state.

In a mounting structure relating to a fifth aspect, in the fourth aspect, the maintaining member urges the pair of nipping members in directions in which the pair of nipping members nip the mounting target object.

In the present aspect, the maintaining member urges the pair of nipping members in directions in which the pair of nipping members nip the mounting target object. Therefore, the pair of nipping members can be made to contact the mounting target object well.

In a mounting structure relating to a sixth aspect, in the fourth or fifth aspect, a base portion side maintaining member disposed at a position corresponding to the base portion side contacting portion, and a non-base portion side maintaining member disposed at a position corresponding to the non-base portion side contacting portion, are provided as the maintaining member.

In the present aspect, the base portion side maintaining member that is disposed at a position corresponding to the base portion side contacting portion, and the non-base portion side maintaining member that is disposed at a position corresponding to the non-base portion side contacting portion, are provided as the maintaining member.

Therefore, the natural frequency can be raised effectively as compared with an aspect in which only one of the base portion side maintaining member and the non-base portion side maintaining member is provided.

In a mounting structure relating to a seventh aspect, in any of the fourth through the sixth aspects, the maintaining member has a pair of pressing walls pressing the pair of nipping members, and a pair of joining walls joining the pair of pressing walls.

In the present aspect, the maintaining member has the pair of pressing walls that press the pair of nipping members, and the pair of joining walls that join the pair of pressing walls. Therefore, the maintaining member can be disposed so as to surround the pair of nipping members.

In a mounting structure relating to an eighth aspect, in any of the fourth through the seventh aspects, the maintaining member is disposed so as to surround the pair of nipping members, and plural projections, which are for maintaining a state of contact of the contacting member and the mounting target object, are formed at places where the pair of nipping members and the maintaining member contact.

In the present aspect, the maintaining member is disposed so as to surround the pair of nipping members. Therefore, it is difficult for the maintaining member to come out of place. However, if the shape of the maintaining member warps for some reason, there is the concern that the state of contact of the contacting member, which has the pair of nipping members, and the mounting target object will change from the desired state.

Thus, in the present aspect, the plural projections for maintaining the state of contact of the contacting member and the mounting target object are formed at places where the pair of nipping members and the maintaining member contact.
Therefore, even if the shape of the maintaining member warps slightly, the state in which the pair of nipping members and the maintaining member contact can be maintained at the respective positions where the plural projections are formed. As a result, the contacting state of the contacting member and the mounting target object can be maintained appropriately.

Note that the embodiment that is described hereinafter describes an example in which the projections are projections that extend in rectilinear shapes in the same direction as the direction in which the maintaining member is mounted. However, the present aspect is not limited to this. The projections of the present aspect do not have to be projections that extend in rectilinear shapes, and may be point-shaped projections.

Further, although the embodiment described hereinafter describes an example in which the projections are formed at the maintaining member, the present aspect is not limited to this. The projections of the present aspect may be formed at the pair of nipping members.

In a mounting structure relating to a ninth aspect, in any of the first through the eighth aspects, the extending portion is a conductive member, and a portion, which is at a side opposite a side supported at the supporting portion, of the extending portion is connected to a connector.

In the present aspect, the extending portion is a conductive member. Further, the portion, which is at the side opposite the side supported at the supporting portion, of the extending portion is connected to a connector.

Therefore, in a connecting structure of a connector and a connection target object that has the mounting structure of the present aspect, there can be realized a connecting structure in which slight sliding wear or the like between the extending portion that is a conductive member and a terminal of the connector is suppressed.

In a mounting structure relating to a tenth aspect, in the ninth aspect, the connector is a floating connector.

In the present aspect, the connector is a floating connector.

Because the portion of the extending portion, which portion is at the side opposite the side supported at the supporting portion, is connected to the floating connector, it is easy for the extending portion to vibrate. Accordingly, vibration suppression due to the technique of the present disclosure is particularly effective.

In a mounting structure relating to an eleventh aspect, in the tenth aspect, the connector has a terminal, and the terminal has a displaced portion contacting the extending portion, and a spring portion elastically supporting the displaced portion, and a plate thickness direction of the spring portion is oriented in a given virtual plane, and at least one of the base portion side contacting portion and the non-base portion side contacting portion contacts the mounting target object from two directions that face one another and run along the virtual plane.

In the present aspect, the plate thickness direction of the spring portion of the terminal of the connector is oriented in a given virtual plane. Therefore, it is easy for the displaced portion to be displaced in a direction running along this virtual plane.

Here, in the present aspect, the two directions that face one another (the two directions in which at least one of the base portion side contacting portion and the non-base portion side contacting portion contacts the mounting target object) are directions running along this virtual plane.
Therefore, vibration of the extending portion can be suppressed effectively.

In a mounting structure relating to a twelfth aspect, in any of the ninth through the eleventh aspects, the connector is a bottom-entry-type.

In the present aspect, the connector is a bottom-entry-type.

Therefore, it is easy for the extending portion to be long, and it is easy for vibration to occur. Accordingly, vibration suppression due to the technique of the present disclosure is particularly effective.

In a mounting structure relating to a thirteenth aspect, in any of the first through the twelfth aspects, the supporting portion is an insulating member, and the extending portion is a terminal held at the insulating member.

In the present aspect, the supporting portion is an insulating member, and the extending portion is a terminal held at the insulating member. Therefore, vibration of the terminal held at the insulating member can be suppressed.

A mounted member relating to a fourteenth aspect is a mounted member for mounting to a mounting target object, wherein the mounting target object has a supporting portion, and an extending portion supported at the supporting portion and having a shape of extending from the supporting portion, and the extending portion has a base portion that is a portion near the supporting portion, and a non-base portion that is a portion far from the supporting portion, and the mounted member has a base portion side contacting portion that contacts at least one of the supporting portion and the base portion, and a non-base portion side contacting portion that contacts the non-base portion.

The present aspect relates to mounted member for mounting to a mounting target object. By mounting the mounted member to the mounting target object, a mounting structure or a connecting structure in which vibration of an extending portion is suppressed can be realized.

A connecting structure relating to a fifteenth aspect is a connecting structure having a connection target object and a connector connected to the connection target object, wherein the connection target object has a mounting target object and a mounted member mounted to the mounting target object, and the mounting target object has a supporting portion, and an extending portion supported at the supporting portion and having a shape of extending from the supporting portion, and the extending portion has a base portion that is a portion near the supporting portion, and a non-base portion that is a portion far from the supporting portion, and the mounted member has a base portion side contacting portion that contacts at least one of the supporting portion and the base portion, and a non-base portion side contacting portion that contacts the non-base portion.

The present aspect relates a connecting structure of a connection target object and a connector. Because the connection target object has the mounting structure relating to the first aspect, slight sliding wear or the like between the extending portion and a terminal of the connector can be suppressed.

### BRIEF DESCRIPTION OF DRAWINGS

FIG. 1 is an exploded perspective view of a connecting structure.

FIG. 2 is a perspective view of the connecting structure.

FIG. 3 is a cross-sectional view of the connecting structure.

FIG. 4 is a cross-sectional view of the connecting structure.

FIG. 5 is a cross-sectional view illustrating a mounting target object and a pair of nipping members.

FIG. 6 is a cross-sectional view along line 6-6 of FIG. 3.

FIG. 7 is a cross-sectional view along line 7-7 of FIG. 3.

FIG. 8 is a cross-sectional view along line 8-8 of FIG. 3.

FIG. 9 is a cross-sectional view along line 9-9 of FIG. 3.

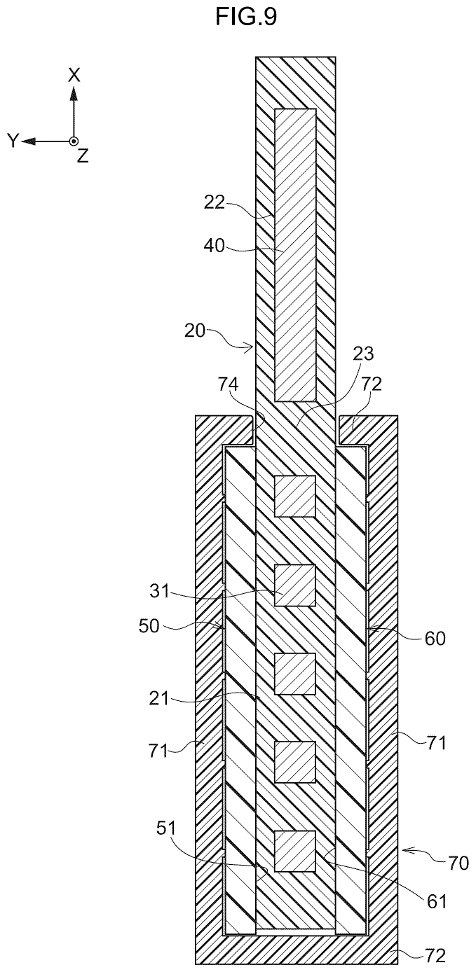

FIG. 10 is a perspective view of the mounting target object.

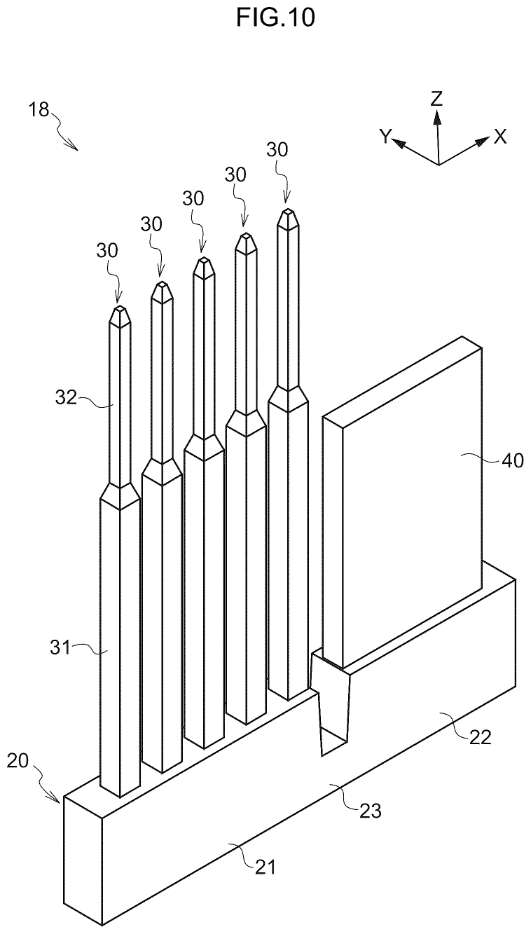

FIG. 11 is a perspective view of the pair of nipping members.

FIG. 12 is another perspective view of the pair of nipping members.

FIG. 13 is a perspective view of plural maintaining members.

FIG. 14 is an exploded perspective view of a connector.

### DESCRIPTION OF EMBODIMENTS

Preferred embodiments of the present disclosure are described hereinafter.

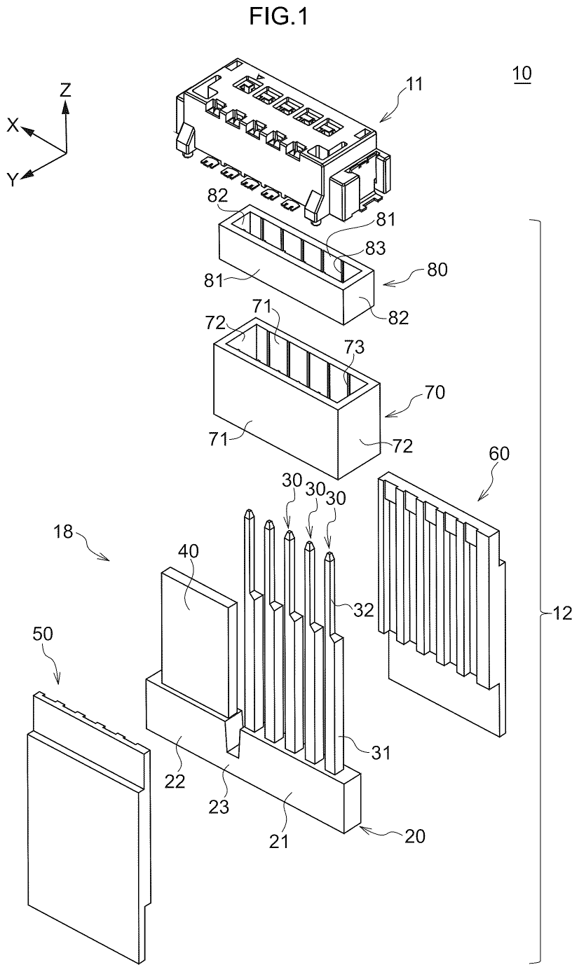

FIG. 1 through FIG. 4 illustrate a connecting structure 10 relating to the present embodiment.

The connecting structure 10 has a connector 11 and a connection target object 12. Namely, the connecting structure 10 is a connecting structure of the connector 11 and the connection target object 12.

### Connector 11

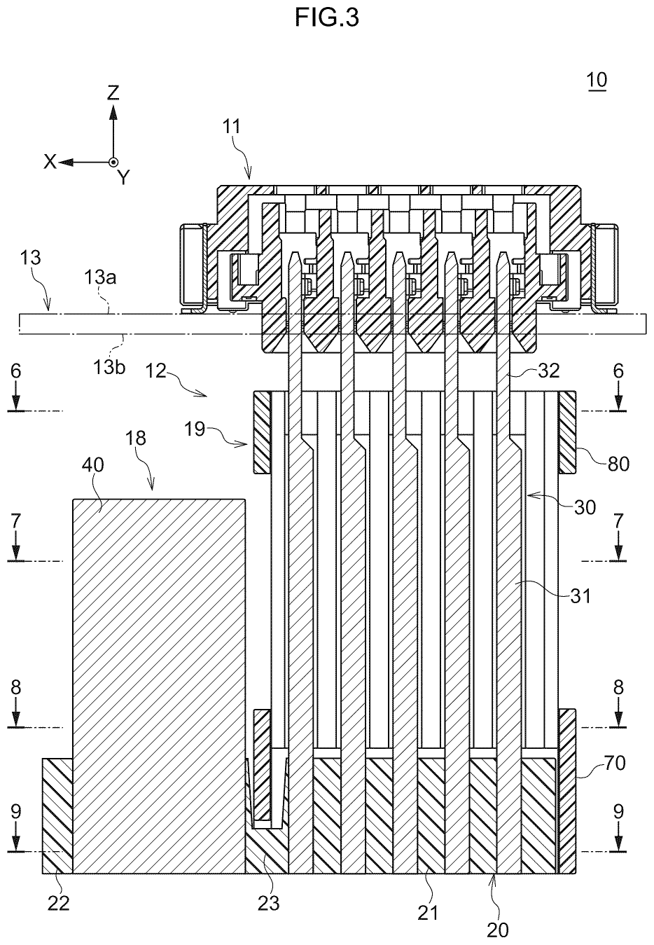

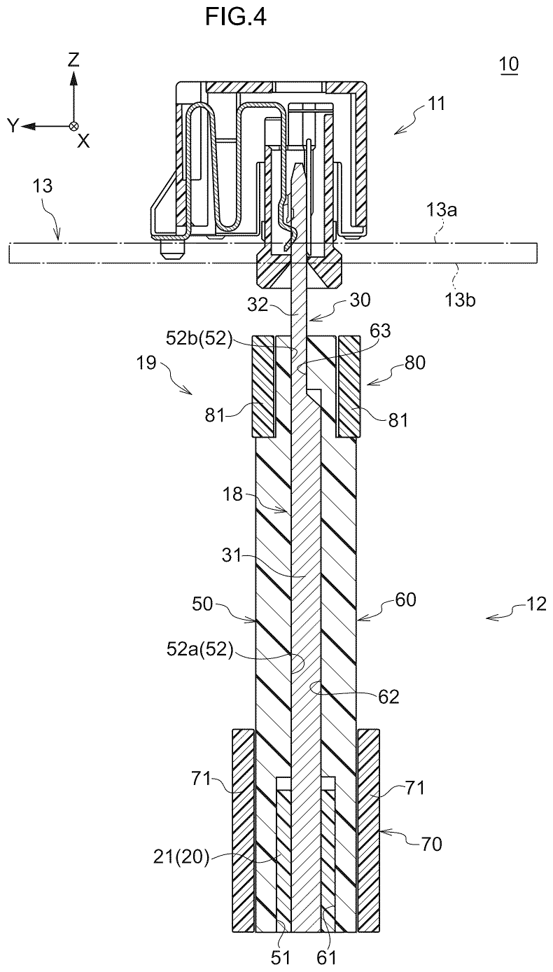

As illustrated in FIG. 3 and FIG. 4, the connector 11 is mounted to an upper surface 13a of a substrate 13. The connector 11 is a bottom-entry-type connector. The connection target object 12 is connected to the connector 11 from a lower surface 13b side of the substrate 13.

The connector 11 is a so-called floating connector.

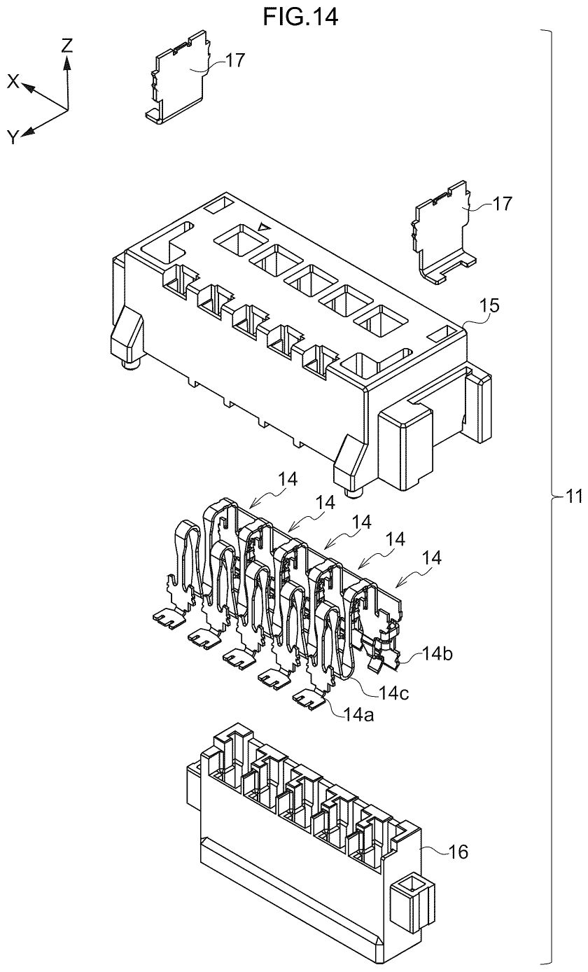

As illustrated in FIG. 14, the connector 11 has plural (five) terminals 14, a fixed housing 15, a movable housing 16, and plural (two) reinforcing members 17.

The respective terminals 14 electrically relay the substrate 13 and pin terminals 30. The fixed housing 15 is fixed to the substrate 13 by the plural terminals 14 and the plural reinforcing members 17. The movable housing 16 is structured so as to be able to move with respect to the fixed housing 15. The plural reinforcing members 17 reinforce the fixing of the fixed housing 15 to the substrate 13.

The plural terminals 14 have the same structures as one another. The plural terminals 14 are arrayed in a row with the X direction being the arraying direction thereof.

The terminal 14 has a fixed portion 14a fixed to the substrate 13, a displaced portion 14b that is displaceable with respect to the fixed portion 14a, and a spring portion 14c connecting the fixed portion 14a and the displaced portion 14b.

The fixed portions 14a are connected to the substrate 13 and are held by the fixed housing 15.

The displaced portions 14b are held by the movable housing 16 and contact the pin terminals 30. The displaced portions 14b contact the pin terminals 30 so as to nip the pin terminals 30 in the Y direction.

The spring portions 14c have plural portions that are bent in the plate thickness direction. At the entireties of the spring portions 14c, the plate thickness directions thereof face a direction running along a plane orthogonal to the X direction. Therefore, the displaced portions 14b are more easily displaced in the Y direction than in the X direction.

The reinforcing members 17 are mounted to the X direction both sides of the fixed housing 15, and are joined to the substrate 13.

### Connection Target Object 12

The connection target object 12 is the target object to which the connector 11 is connected.

The connection target object 12 has a mounting target object 18 and a mounted member 19. The connection target object 12 has the mounting structure 18, 19 in which the mounted member 19 is mounted to the mounting target object 18.

### Mounting Target Object 18

The mounting target object 18 is the target object to which the mounted member 19 is mounted. The mounting target object 18 has an insulating member 20 (e.g., a resin member), the plural pin terminals 30, and an adjacent conductive member 40. Hereinafter, there are cases in which the insulating member 20 is called the supporting portion 20, and the pin terminals 30 are called the extending portions 30. The pin terminals 30 are used as terminals for signals, for example.

The plural pin terminals 30 and the adjacent conductive member 40 are supported by the insulating member 20 and extend in the upward direction (the +Z direction) from the insulating member 20. The mounting target object 18 is fabricated by, for example, insert molding in which the plural pin terminals 30 and the adjacent conductive member 40 are made into an insert molded product.

The insulating member 20 is fixed to an unillustrated housing or the like. The insulating member 20 has a first supporting portion 21 that supports the plural pin terminals 30, a second supporting portion 22 that supports the adjacent conductive member 40, and a joining portion 23 that joins the first supporting portion 21 and the second supporting portion 22. Note that the plural pin terminals 30 and the adjacent conductive member 40 extend from the unillustrated housing or the like.

The Y dimensions of the first supporting portion 21, the joining portion 23 and the second supporting portion 22 are the same.
The upper surface of the first supporting portion 21 and the upper surface of the second supporting portion 22 are positioned at the same height. The upper surface of the joining portion 23 is positioned further toward the lower side than the upper surface of the first supporting portion 21.

The plural pin terminals 30 are arrayed in a row with the X direction being the arraying direction thereof. The plural pin terminals 30 have the same structures as one another.

The pin terminal 30 has a main body portion 31 and a distal end portion 32. Hereinafter, there are cases in which the main body portion 31 is called the base portion 31, and the distal end portion 32 is called the non-base portion 32.

The cross-sectional shape (the shape of the cross-section orthogonal to the Z direction) of the distal end portion 32 is smaller than that of the main body portion 31. Specifically, the X dimension of the distal end portion 32 is smaller than the X dimension of the main body portion 31, and the Y dimension of the distal end portion 32 is smaller than the Y dimension of the main body portion 31. The surface at the +X direction side of the main body portion 31 is positioned in the same plane as the surface at the +X direction side of the distal end portion 32. The surface at the +Y direction side of the main body portion 31 is positioned in the same plane as the surface at the +Y direction side of the distal end portion 32.

More specifically, the Z dimension of the main body portion 31 is larger than the Z dimension of the distal end portion 32. The main body portion 31 and the distal end portion 32 both have rectangular (specifically, square) cross-sectional shapes. The Y dimension of the pin terminal 30 (i.e., the Y dimension of the main body portion 31) is smaller than the Y dimension of the first supporting portion 21 of the insulating member 20.

The adjacent conductive member 40 is used as a terminal for a power source for example. Note that the adjacent conductive member 40 is drawn in a simplified manner in the respective figures.

### Mounted Member 19

The mounted member 19 is a member that is mounted to the mounting target object 18. The mounted member 19 is a member for suppressing vibration of the plural pin terminals 30. The dimensions and the like of the respective portions of the mounted member 19 are set so as to suppress vibration of the plural pin terminals 30 in the state in which the connection target object 12 is connected to the connector 11.

The mounted member 19 has a pair of nipping members 50, 60, and plural (two) maintaining members 70, 80.

The pair of nipping members 50, 60 are disposed so as to nip the mounting target object 18 in the Y direction (nipping direction). Hereinafter, there are cases in which the Y direction is called the nipping direction.
The plural maintaining members 70, 80 maintain the state in which the pair of nipping members 50, 60 are disposed so as to nip the mounting target object 18 from the Y direction.

The pair of nipping members 50, 60 are structured from the one side nipping member 50 and the another side nipping member 60. The one side nipping member 50 and the another side nipping member 60 have similar structures. Hereinafter, when not differentiating therebetween, the one side nipping member 50 and the another side nipping member 60 are simply called the nipping members 50, 60.

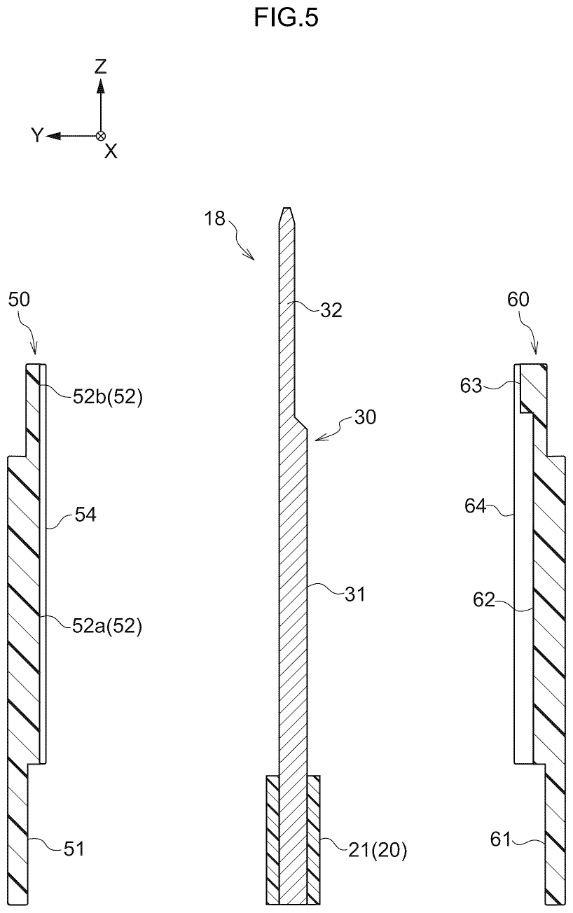

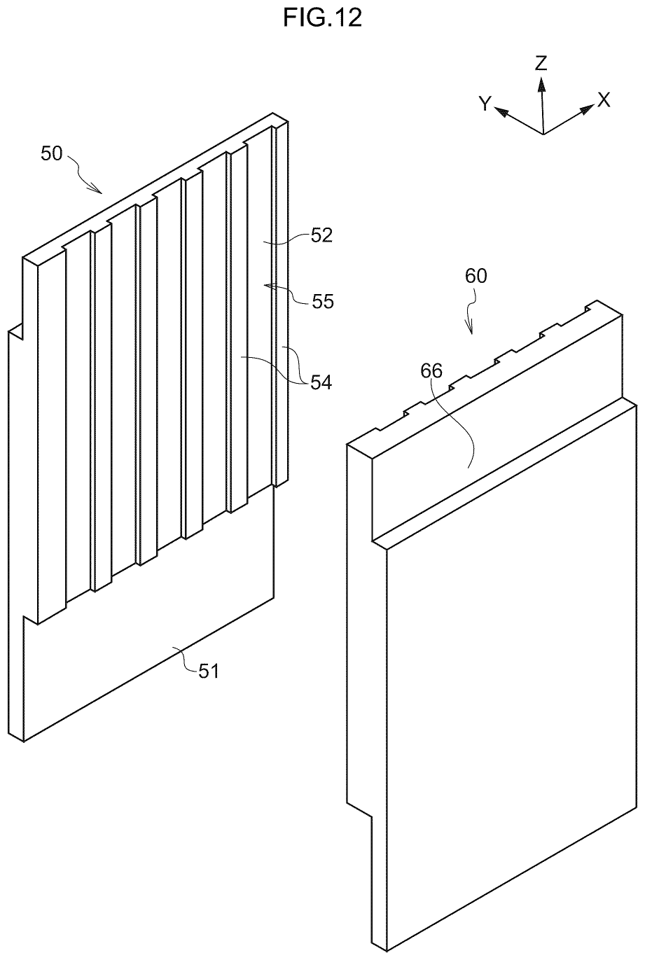

As illustrated in FIG. 5 and FIG. 12, the one side nipping member 50 has a first contacting surface 51 contacting the insulating member 20 from a nipping direction one side (the +Y direction side), and a second contacting surface 52 contacting the pin terminals 30 from the nipping direction one side.

The first contacting surface 51 and the second contacting surface 52 of the one side nipping member 50 are both flat surfaces whose normal directions face the nipping direction another side. The second contacting surface 52 of the one side nipping member 50 is positioned further toward the nipping direction another side than the first contacting surface 51.

As illustrated in FIG. 4, at the pin terminals 30, the +Y direction side surfaces of the main body portions 31 are positioned in the same plane as the +Y direction side surfaces of the distal end portions 32. Therefore, the second contacting surface 52 contacts both the main body portions 31 and the distal end portions 32 of the pin terminals 30 from the nipping direction one side.

Specifically, the second contacting surface 52 contacts the main body portions 31 of the pin terminals 30 at a lower portion 52a of the second contacting surface 52, and contacts the distal end portions 32 of the pin terminals 30 at an upper portion 52b of the second contacting surface 52. The first contacting surface 51 and the lower portion 52a of the second contacting surface 52 correspond to the “base portion side contacting portion” in the present disclosure, and the upper portion 52b of the second contacting surface 52 corresponds to the “non-base portion side contacting portion” in the present disclosure.

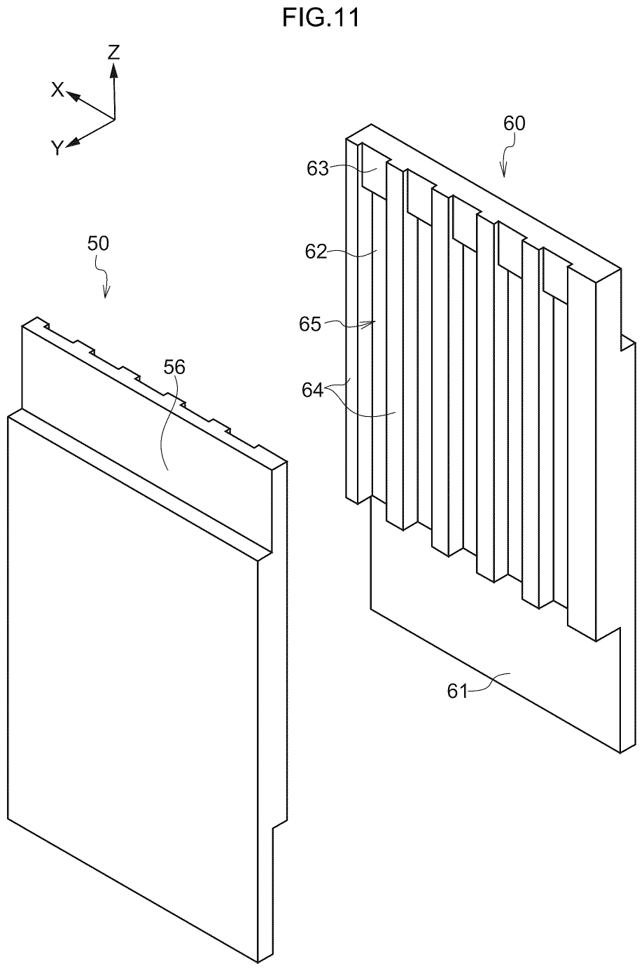

As illustrated in FIG. 5 and FIG. 11, the another side nipping member 60 has a first contacting surface 61 that contacts the insulating member 20 from the nipping direction another side (the −Y direction side), a second contacting surface 62 that contacts the main body portions 31 of the pin terminals 30 from the nipping direction another side, and a third contacting surface 63 that contacts the distal end portions 32 of the pin terminals 30 from the nipping direction another side.

The first contacting surface 61, the second contacting surface 62 and the third contacting surface 63 of the another side nipping member 60 are all flat surfaces whose normal directions face the nipping direction one side (the +Y direction).
The second contacting surface 62 of the another side nipping member 60 is positioned further toward the nipping direction one side than the first contacting surface 61. The third contacting surface 63 of the another side nipping member 60 is positioned further toward the nipping direction one side than the second contacting surface 62.

As illustrated in FIG. 12, the one side nipping member 50 has plural (six) projecting walls 54. Each of the plural projecting walls 54 projects out toward the nipping direction another side and extends in the Z direction. Placement grooves 55, in which the respective pin terminals 30 are disposed, are formed between the two adjacent projecting walls 54 among the plural projecting walls 54. The bottom surfaces of the placement grooves 55 are the second contacting surface 52. Therefore, the second contacting surface 52 is divided into plural (five) sections.

As illustrated in FIG. 11, the another side nipping member 60 has plural (six) projecting walls 64. Each of the plural projecting walls 64 projects out toward the nipping direction one side and extends in the Z direction. Placement grooves 65, in which the respective pin terminals 30 are disposed, are formed between the two adjacent projecting walls 64 among the plural projecting walls 64. The bottom surfaces of the placement grooves 65 are the second contacting surface 62 and the third contacting surface 63. Therefore, the second contacting surface 62 and the third contacting surface 63 are divided into plural (five) sections.

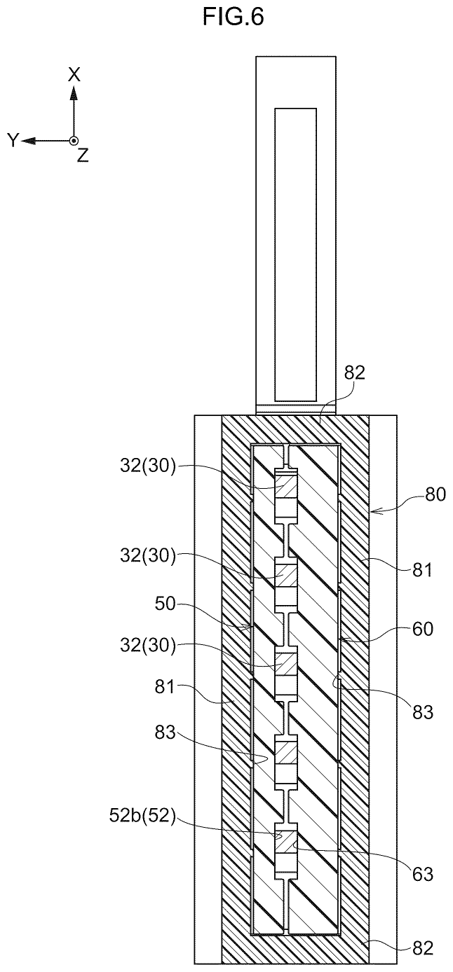

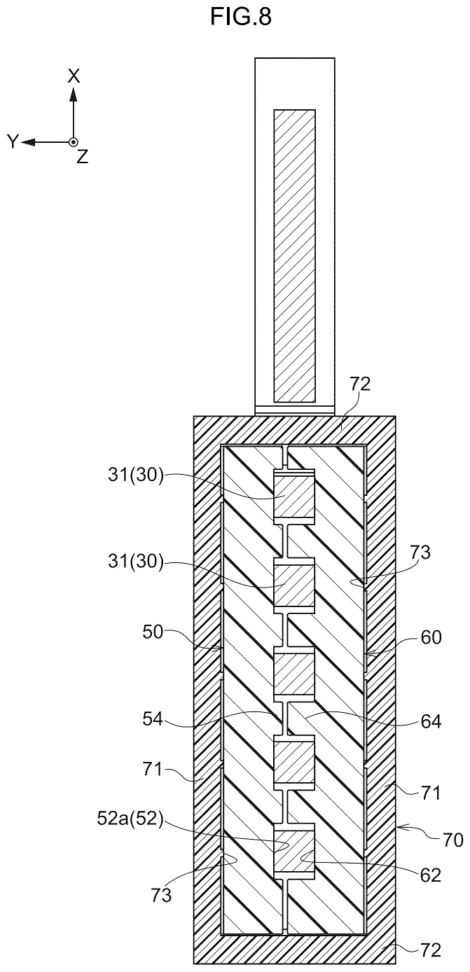

As illustrated in FIG. 6 through FIG. 8, the plural projecting walls 54 of the one side nipping member 50 and the plural projecting walls 64 of the another side nipping member 60 are formed so as to not contact in the nipping direction. Due thereto, the one side nipping member 50 and the another side nipping member 60 do not contact one another.

The amount of projection (the amount of projection in the Y direction) of the projecting walls 54 with respect to the second contacting surface 52 of the one side nipping member 50 is substantially the same as the amount of projection of the projecting walls 64 with respect to the third contacting surface 63 of the another side nipping member 60. Further, the amount of projection of the projecting walls 54 with respect to the second contacting surface 52 of the one side nipping member 50 is smaller than the amount of projection of the projecting walls 64 with respect to the second contacting surface 52 of the another side nipping member 60.

As illustrated in FIG. 11, a concave portion 56 that is recessed toward the nipping direction another side is formed in the surface at the nipping direction one side (the +Y direction) of the one side nipping member 50.

As illustrated in FIG. 12, a concave portion 66 that is recessed toward the nipping direction one side is formed in the surface at the nipping direction another side (the −Y direction) of the another side nipping member 60.
The concave portion 56 and the concave portion 66 are formed at the upper portions of the pair of nipping members 50, 60. The second maintaining member 80 that is described later is mounted to the portions, at which the concave portion 56 and the concave portion 66 are formed, of the pair of nipping members 50, 60.
Due thereto, the sectional surface areas at the upper portions of the pair of nipping members 50, 60 are made smaller.

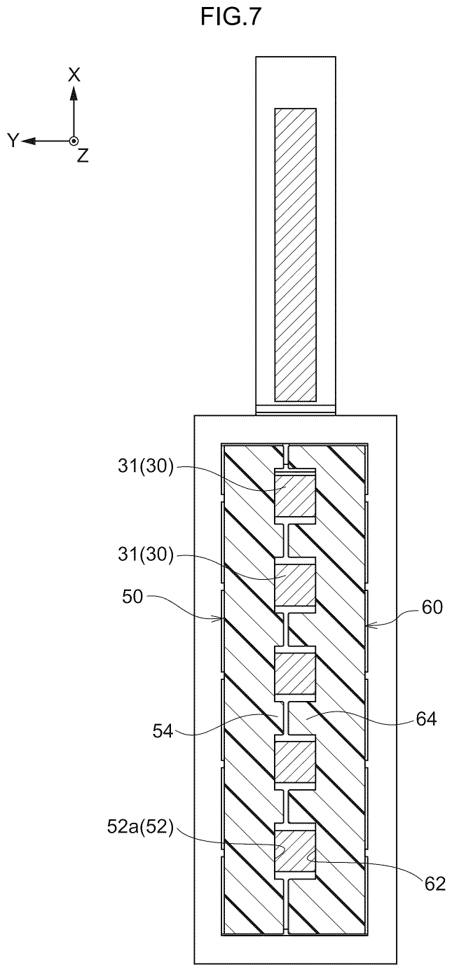

As illustrated in FIG. 7, the distance in the X direction between the projecting walls 54 that are adjacent is larger than the X dimension of the main body portion 31 of the pin terminal 30, and specifically, is 1.1 times or more larger. The main body portion 31 of the pin terminal 30 is disposed with distances in the X direction between the main body portion 31 and both of the two projecting walls 54 that are adjacent to that main body portion 31.

The same holds for the distance in the X direction between the projecting walls 64 that are adjacent.

The pair of nipping members 50, 60 are formed of a synthetic resin for example, but may be formed of another material.

### Plural Maintaining Members 70, 80

The plural maintaining members 70, 80 are structured from the first maintaining member 70 and the second maintaining member 80.

In the state in which the pair of nipping members 50, 60 are disposed so as to nip the mounting target object 18 in the from the Y direction, first, the first maintaining member 70 is mounted from the +Z direction side, and next, the second maintaining member 80 is mounted from the +Z direction side.

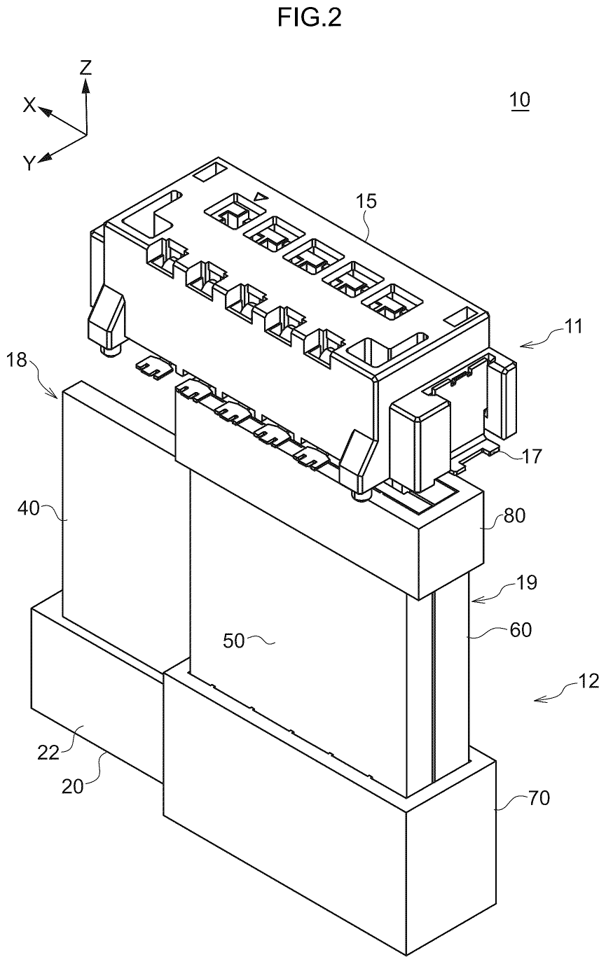

As illustrated in FIG. 2, the first maintaining member 70 is in a state of surrounding the lower portions of the pair of nipping members 50, 60, and the second maintaining member 80 is in a state of surrounding the upper portions of the pair of nipping members 50, 60. Due thereto, the state in which the pair of nipping members 50, 60 are disposed so as to nip the mounting target object 18 in from the Y direction is maintained.

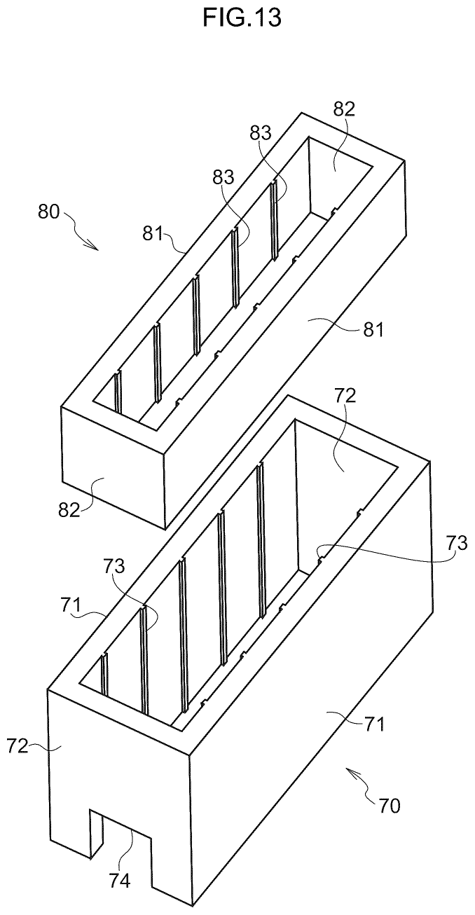

As illustrated in FIG. 13, the first maintaining member 70 has a pair of pressing walls 71 that press the lower portions of the pair of nipping members 50, 60 from the nipping direction outer sides, and a pair of joining walls 72 that join the pair of pressing walls 71 together. The first maintaining member 70 is formed in the shape of a quadrangular tube by the pair of pressing walls 71 and the pair of joining walls 72.

The pair of pressing walls 71 have structures that are symmetrical in the nipping direction.

Each of the pressing walls 71 has plural (five) projections 73. The plural projections 73 are formed at the surfaces that are at the nipping direction inner sides of the pressing walls 71. The respective projections 73 are projections that extend in the vertical direction, and are formed continuously from the upper ends to the lower ends of the pressing walls 71. The plural projections 73 contact the pair of nipping members 50, 60.
The distances in the nipping direction between the projections 73 of the one pressing wall 71 and the projections 73 of the another pressing wall 71 are set such that the respective projections 73 are crushed to a certain extent in the state in which the first maintaining member 70 is mounted to the pair of nipping members 50, 60.

The X direction positions of the plural projections 73 provided at one of the pressing walls 71 coincide with the X direction positions of the plural projections 73 provided at the another of the pressing walls 71.

The X direction positions of the plural projections 73 respectively are positions corresponding to the plural pin terminals 30. Specifically, the X direction positions of the plural projections 73 coincide with the X direction positions of the central axes of the main body portions 31 of the plural pin terminals 30. Therefore, the pair of nipping members 50, 60 reliably contact the respective pin terminals 30.

As illustrated in FIG. 13, one of the joining walls 72 of the pair of joining walls 72 has a cut-out portion 74. The cut-out portion 74 is a cut-out provided in the lower end of the joining wall 72 and opens toward the lower side. The joining portion 23 of the insulating member 20 is disposed in the cut-out portion 74.

The second maintaining member 80 has a pair of pressing walls 81 that press the upper portions of the pair of nipping members 50, 60 from the nipping direction outer sides, and a pair of joining walls 82 that join the pair of pressing walls 81 together. The second maintaining member 80 is formed in the shape of a quadrangular tube by the pair of pressing walls 81 and the pair of joining walls 82.

The X dimension of the second maintaining member 80 is the same as the X dimension of the first maintaining member 70, and the Y dimension of the second maintaining member 80 is smaller than the Y dimension of the first maintaining member 70. Due thereto, the sectional surface area of the second maintaining member 80 is smaller than, and the mass thereof is smaller than, those of the first maintaining member 70.

The pair of pressing walls 81 have structures that are symmetrical in the nipping direction.

Each of the pressing walls 81 has plural (five) projections 83. The plural projections 83 are formed at the surfaces that are at the nipping direction inner sides of the pressing walls 81. The respective projections 83 are projections that extend in the vertical direction, and are formed continuously from the upper ends to the lower ends of the pressing walls 81. The plural projections 83 contact the pair of nipping members 50, 60.
The distances in the nipping direction between the projections 83 of the one pressing wall 81 and the projections 83 of the another pressing wall 81 are set such that the respective projections 83 are crushed to a certain extent in the state in which the second maintaining member 80 is mounted to the pair of nipping members 50, 60.

The X direction positions of the plural projections 83 provided at one of the pressing walls 81 coincide with the X direction positions of the plural projections 83 provided at the another of the pressing walls 81. The X direction positions of the plural projections 83 coincide with the X direction positions of the plural projections 73.

The plural maintaining members 70, 80 are formed of a synthetic resin for example, but may be formed of another material.

### Operation and Effects

Operation and effects of the present embodiment are described next.

In the present embodiment, as illustrated in FIG. 1 and FIG. 2, the mounting structure 18, 19 of the connection target object 12 of the connector 11 has the mounting target object 18. The mounting target object 18 has the supporting portion 20 and the plural extending portions 30 having shapes that extend from the supporting portion 20.

Although the extending portions 30 are supported by the supporting portion 20, the extending portions 30 have shapes that extend from the supporting portion 20, and therefore, it is easy for the natural frequency of the extending portions 30 to be low. In a case in which the mounting structure 18, 19 is placed in a vibration environment, if the frequency of the vibration environment is near the natural frequency of the extending portions 30, there is the concern that resonance will occur and that the extending portions 30 will vibrate greatly.

Further, in the present embodiment, as illustrated in FIG. 2, the mounting structure 18, 19 has the mounted member 19 that is mounted to the mounting target object 18. As illustrated in FIG. 4, the mounted member 19 has the base portion side contacting portions 51, 52a, 61, 62 and the non-base portion side contacting portions 52b, 63. The base portion side contacting portions 51, 52a, 61, 62 contact at least one of the supporting portion 20 or the base portions 31, and the non-base portion side contacting portions 52b, 63 contact the non-base portions 32.

Therefore, the natural frequency of the extending portions 30 to which the mounted member 19 is mounted is higher than the natural frequency of the extending portions 30 to which the mounted member 19 is not mounted.
Accordingly, in accordance with the present disclosure, the natural frequency can be adjusted by the mounted member 19, and as a result, vibration of the extending portions 30 can be suppressed.

Note that, in the present embodiment, base portion means the portion of the extending portion that is near to the supporting portion, and non-base portion means the portion of the extending portion that is far from the supporting portion. Therefore, of the main body portions 31 of the pin terminals 30, only the lower portions thereof can be understood as being the base portions, and the upper portions of the main body portions 31 and the distal end portions 32 can be understood as being the non-base portions. When understood in this way, of the mounted member 19, the portion thereof that contacts the upper portions of the main body portions 31 also corresponds to the non-base portion side contacting portion.

Further, in the present embodiment, as illustrated in FIG. 4 through FIG. 8, at least one of (in the present embodiment, both of) the base portion side contacting portions 51, 52a, 61, 62 and the non-base portion side contacting portions 52b, 63 contact the mounting target object 18 from two directions that face one another (the +Y direction and the −Y direction).

Therefore, the natural frequency relating to vibration in the two directions that face one another can be raised effectively.

Further, in the present embodiment, the mounted member 19 has the contacting members 50, 60 that contact the mounting target object 18. The contacting members 50, 60 have the pair of nipping members 50, 60 that are formed as bodies separate from one another. The pair of nipping members 50, 60 are disposed so as to nip the mounting target object 18 therebetween.

Therefore, the work of mounting the mounted member 19 to the mounting target object 18 is not press-fitting. As a result, scraping of the surfaces of the mounting target object 18 and the mounted member 19 at a time of press-fitting can be avoided.

Further, in the present embodiment, the mounted member 19 has the maintaining members 70, 80 that are formed as bodies separate from the pair of nipping members 50, 60.
The maintaining members 70, 80 maintain the state in which the pair of nipping members 50, 60 are disposed so as to nip the mounting target object 18.
Therefore, there is no need for the pair of nipping members 50, 60 themselves to have a structure for maintaining the aforementioned state.

Further, in the present embodiment, the maintaining members 70, 80 urge the pair of nipping members 50, 60 in directions in which the pair of nipping members 50, 60 nip the mounting target object 18.

Therefore, the pair of nipping members 50, 60 can be made to contact the mounting target object 18 well.

Further, in the present embodiment, the base portion side maintaining member 70 that is disposed at a position corresponding to the base portion side contacting portions 51, 52a, 61, 62, and the non-base portion side maintaining member 80 that is disposed at a position corresponding to the non-base portion side contacting portions 52b, 63, are provided as the maintaining members 70, 80.

Therefore, the natural frequency can be raised effectively as compared with an aspect in which only one of the base portion side maintaining member 70 and the non-base portion side maintaining member 80 is provided.
In particular, in the present embodiment, the base portion side maintaining member 70 is disposed in a range spanning over the boundary between the supporting portion 20 and the extending portions 30 in the Z direction that is the extending directions of the extending portions 30.
Therefore, the natural frequency can be raised even more effectively.
Further, in the present embodiment, the non-base portion side maintaining member 80 is disposed in a range spanning over the boundary between the main body portions 31 and the distal end portions 32 of the extending portions 30 in the Z direction that is the extending directions of the extending portions 30. Therefore, the natural frequency can be raised even more effectively.

Further, in the present embodiment, as illustrated in FIG. 13, the maintaining members 70, 80 have the pairs of pressing walls 71, 81 that press the pair of nipping members 50, 60, and the pairs of joining walls 72, 82 that join the pairs of pressing walls 71, 81.

Therefore, as illustrated in FIG. 2, the maintaining members 70, 80 can be disposed so as to surround the pair of nipping members 50, 60.

Further, in the present embodiment, as illustrated in FIG. 2, the maintaining members 70, 80 are disposed so as to surround the pair of nipping members 50, 60. Therefore, it is difficult for the maintaining members 70, 80 to come out of place.

However, if the shapes of the maintaining members 70, 80 warp for some reason, there is the concern that the state of contact between the contacting members 50, 60 that have the pair of nipping members 50, 60 and the mounting target object 18 will change from the desired state. Specifically, for example, in the case of the maintaining members 70, 80 of the present embodiment, there is the concern that the shapes of the maintaining members 70, 80 will warp such that the vicinities of the centers of the pairs of pressing walls 71, 81 (vicinities of the centers in the X direction) will move apart from one another. In this case, there is the concern that, in the vicinities of the centers in the X direction, gaps will form between the maintaining members 70, 80 and the pair of nipping members 50, 60, and as a result, the state of contact between the contacting members 50, 60 and the mounting target object 18 will change from the desired state. Thus, in the present embodiment, the plural projections 73, 83 for maintaining the state of contact between the contacting members 50, 60 and the mounting target object 18 are formed at places where the pair of nipping members 50, 60 and the maintaining members 70, 80 contact.
Therefore, even if the shapes of the maintaining members 70, 80 warp slightly, the state in which the pair of nipping members 50, 60 and the maintaining members 70, 80 contact can be maintained at the respective positions where the plural projections 73, 83 are formed. As a result, the contacting state of the contacting members 50, 60 and the mounting target object 18 can be maintained appropriately.

Further, in the present embodiment, the extending portions 30 are the conductive members 30. The portions of the extending portions 30, which are at the sides opposite the sides supported at the supporting portion 20, are connected to the connector 11.

Therefore, as illustrated in FIG. 3 and FIG. 4, the connecting structure 10 in which slight sliding wear and the like between the extending portions 30 that are the conductive members 30 and the terminals 14 of the connector 11 are suppressed, which is the connecting structure 10 of the connector 11 and the connection target object 12 that has the mounting structure 18, 19 of the present embodiment, can be realized.

Further, in the present embodiment, the connector 11 is a floating connector.

Because the portions of the extending portions 30, which are at the sides opposite the sides supported at the supporting portion 20, are connected to the floating connector 11, it is easy for the extending portions 30 to vibrate. Accordingly, vibration suppression due to the technique of the present disclosure is particularly effective.

Further, in the present embodiment, as illustrated in FIG. 14, the plate thickness directions of the spring portions 14c of the terminals 14 of the connector 11 are oriented in a given virtual plane (a plane orthogonal to the X direction). Therefore, it is easy for the displaced portions 14b to be displaced in a direction running along this virtual plane (the plane orthogonal to the X direction).

Thus, in the present embodiment, the two directions that face one another (the two directions in which at least one of the base portion side contacting portions 51, 52a, 61, 62 and the non-base portion side contacting portions 52b, 63 contact the mounting target object 18, the nipping direction in the present embodiment) are directions running along this virtual plane (the plane orthogonal to the X direction).
Therefore, vibration of the extending portions 30 can be suppressed effectively.

Further, in the present embodiment, as illustrated in FIG. 4, the connector 11 is a bottom-entry-type.

Therefore, it is easy for the extending portions 30 to be long, and it is easy for vibration to occur. Accordingly, vibration suppression due to the technique of the present disclosure is particularly effective.

Further, in the present embodiment, as illustrated in FIG. 1, the supporting portion 20 is the insulating member 20, and the extending portions 30 are the terminals 30 that are held at the insulating member 20. Therefore, vibration of the terminals 30 that are held at the insulating member 20 can be suppressed.

Although a preferred embodiment of the present disclosure has been described above, the present disclosure is not limited to the above-described embodiment.

### EXPLANATION OF REFERENCE NUMERALS

10 connecting structure
11 connector
12 connection target object
13 substrate
14 terminal
14b displaced portion
14c spring portion
18, 19 mounting structure
18 mounting target object
19 mounted member
20 insulating member (supporting portion)
30 pin terminal (extending portion, conductive member, terminal)
31 main body portion (base portion)
32 distal end portion (non-base portion)
50, 60 pair of nipping members (contacting members)
51, 52a, 61, 62 base portion side contacting portion
52b, 63 non-base portion side contacting portion
70,80 maintaining member
70 first maintaining member (base portion side maintaining member)
80 second maintaining member (non-base portion side maintaining member)
71, 81 pressing wall
72, 82 joining wall
73, 83 projection

1. A mounting structure comprising a mounting target object and a mounted member mounted to the mounting target object, wherein:
the mounting target object has:
a supporting portion, and
an extending portion supported at the supporting portion and having a shape that extends from the supporting portion;
the extending portion has a base portion that is a portion near the supporting portion, and a non-base portion that is a portion far from the supporting portion; and
the mounted member has a base portion side contacting portion that contacts at least one of the supporting portion or the base portion, and a non-base portion side contacting portion that contacts the non-base portion.

2. The mounting structure of claim 1, wherein at least one of the base portion side contacting portion or the non-base portion side contacting portion contacts the mounting target object from two directions that face one another.

3. The mounting structure of claim 1, wherein:
the mounted member has a contacting member that contacts the mounting target object, and
the contacting member has a pair of nipping members that are a pair of nipping members formed as bodies separate from one another and that are disposed so as to nip the mounting target object.

4. The mounting structure of claim 3, wherein:
the mounted member has a maintaining member formed as a body separate from the pair of nipping members, and
the maintaining member maintains a state in which the pair of nipping members are disposed so as to nip the mounting target object.

5. The mounting structure of claim 4, wherein the maintaining member urges the pair of nipping members in directions in which the pair of nipping members nip the mounting target object.

6. The mounting structure of claim 4, wherein
a base portion side maintaining member disposed at a position corresponding to the base portion side contacting portion, and
a non-base portion side maintaining member disposed at a position corresponding to the non-base portion side contacting portion,
are provided as the maintaining member.

7. The mounting structure of claim 4, wherein the maintaining member has:
a pair of pressing walls pressing the pair of nipping members, and
a pair of joining walls joining the pair of pressing walls.

8. The mounting structure of claim 4, wherein:
the maintaining member is disposed so as to surround the pair of nipping members, and
a plurality of projections, which are for maintaining a state of contact of the contacting member and the mounting target object, are formed at places where the pair of nipping members and the maintaining member contact.

9. The mounting structure of claim 1, wherein:
the extending portion is a conductive member, and
a portion, which is at a side opposite from a side supported at the supporting portion, of the extending portion is connected to a connector.

10. The mounting structure of claim 9, wherein the connector is a floating connector.

11. The mounting structure of claim 10, wherein:
the connector has a terminal;
the terminal has:
a displaced portion contacting the extending portion, and
a spring portion elastically supporting the displaced portion;
a plate thickness direction of the spring portion is oriented in a given virtual plane; and
at least one of the base portion side contacting portion or the non-base portion side contacting portion contacts the mounting target object from two directions that face one another and run along the virtual plane.

12. The mounting structure of claim 9, wherein the connector is of a bottom-entry-type.

13. The mounting structure of claim 1, wherein the supporting portion is an insulating member, and the extending portion is a terminal held at the insulating member.

14. A mounted member for mounting to a mounting target object, wherein:
the mounting target object has:
a supporting portion, and
an extending portion supported at the supporting portion and having a shape that extends from the supporting portion;
the extending portion has a base portion that is a portion near the supporting portion, and a non-base portion that is a portion far from the supporting portion; and
the mounted member has a base portion side contacting portion that contacts at least one of the supporting portion or the base portion, and a non-base portion side contacting portion that contacts the non-base portion.

15. A connecting structure having a connection target object and a connector connected to the connection target object, wherein:
the connection target object has a mounting target object and a mounted member mounted to the mounting target object;
the mounting target object has:
a supporting portion, and
an extending portion supported at the supporting portion and having a shape that extends from the supporting portion;
the extending portion has a base portion that is a portion near the supporting portion, and a non-base portion that is a portion far from the supporting portion; and
the mounted member has a base portion side contacting portion that contacts at least one of the supporting portion or the base portion, and a non-base portion side contacting portion that contacts the non-base portion.
